(19) United States
(12) Patent Application Publication
(10) Pub. No.: US 2003/0065633 A1
(43) Pub. Date: Apr. 3, 2003

(54) Configuration of interconnected arithmetic elements, and method for the computer-aided determination of a second state of a system in a first state space from a first state of the system in the first state space

(76) Inventors: Raft Neuneier, Muenchen (DE); Hans-Georg Zimmermann, Starnberg/Percha (DE)

Correspondence Address: STAAS & HALSEY LLP, 700 11TH STREET, NW, SUITE 500, WASHINGTON, DC, 20001, US

(21) Appl. No.: 10/182,599

(22) PCT Filed: Jan. 9, 2001
(86) PCT No.: PCT/DE01/00049

(30) Foreign Application Priority Data
Jan. 31, 2000 (DE) 100 04 064.0

(51) Int. Cl. G06N 3/02

(52) U.S. Cl. 706/15; 706/924; 706/914

(57) ABSTRACT

The invention relates to a configuration of interconnected arithmetic elements and to a method for the computer-aided determination of a second state of a system in a first state space from a first state of the system in the first state space. According to the invention, the first state is transformed into a third state of the system in a second state space. A fourth state of the system in the second state space is determined and a variation between the third state and the forth state is ascertained. The second state is determined by using said variation and the first state.

The invention relates to an arrangement of interconnected computing elements and to a method for computer-aided ascertainment of a second state of the system in a first state space from a first state of the system in the first state space.

[1] discloses the use of an arrangement of interconnected computing elements for ascertaining a state of a system. In addition, [1] discloses the practice of ascertaining a dynamic response for the system or a dynamic process on which the system is based from a plurality of chronologically subsequent states of a system.

In general, a dynamic process on which a system is based is normally described by a state transition description, which is not visible to an observer of the dynamic process, and an output equation, which describes observable variables of the technical dynamic process.

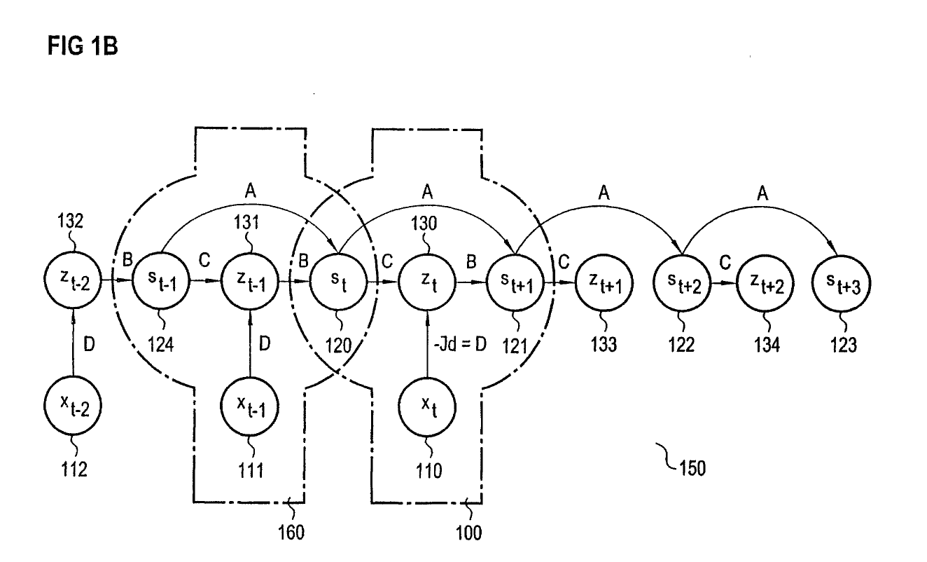

One such structure is shown in FIG. 2.

A dynamic system 200 is subject to the influence of an external input variable x of prescribable dimension, with an input variable xₜ at a time t being denoted by xₜ:

xₜε [symbol] ^{l},

where l denotes a natural number.

The input variable xₜ at a time t causes a change in the dynamic process taking place in the dynamic system 200.

An inner state sₜ (sₜε [symbol] ^{m}) of prescribable dimension m at a time t cannot be observed by an observer of the dynamic system 200.

Depending on the inner state sₜ and the input variable xₜ, a state transition is caused in the inner state sₜ of the dynamic process, and the state of the dynamic process changes to a subsequent state sₜ₊₁ at a subsequent time t+1.

In this case:

sₜ₊₁=f(sₜ,xₜ). (1)

where f(.) denotes a general mapping rule.

An output variable yₜ at a time t, which can be observed by an observer of the dynamic system 200, depends on the input variable xₜ and on the inner state sₜ.

The output variable yₜ (yₜε [symbol] ⁿ) has a prescribable dimension n.

The dependence of the output variable yₜ on the input variable xₜ and on the inner state sₜ of the dynamic process is expressed by the following general rule:

yₜ=g(sₜ,xₜ), (2)

where g(.) denotes a general mapping rule.

To describe the dynamic system 200, [1] uses an arrangement of interconnected computing elements in the form of a neural network of interconnected neurons. The connections between the neurons in the neural network are weighted. The weights in the neural network are combined in a parameter vector v.

An inner state of a dynamic system which is subject to a dynamic process is thus dependent, in accordance with the following rule, on the input variable xₜ and on the inner state of the previous time sₜ and on the parameter vector v.

sₜ₊₁=NN(v,sₜ,xₜ) (3)

where NN(.) denotes a mapping rule prescribed by the neural network.

[2] discloses an arrangement referred to as a Time Delay Recurrent Neural Network (TDRNN).

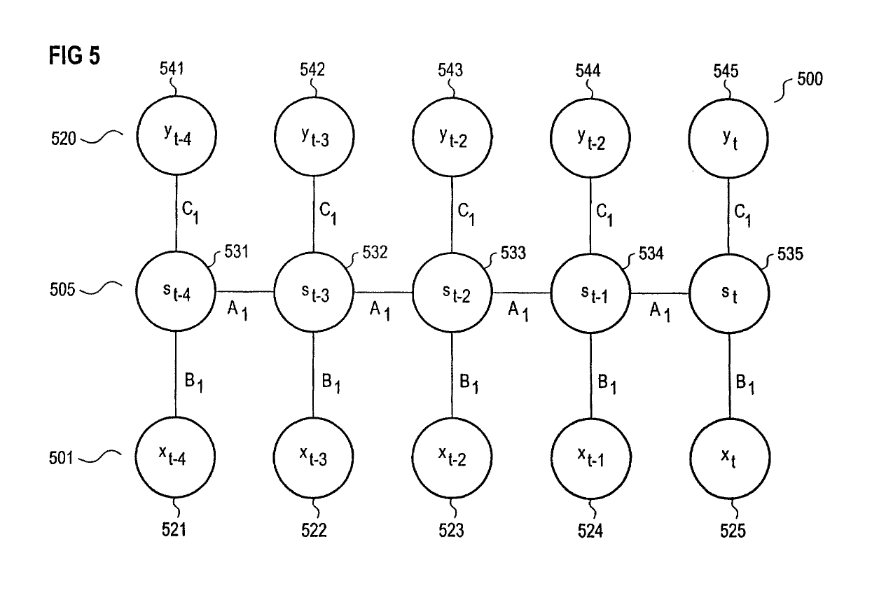

The known TDRNN is illustrated in FIG. 5 as a neural network 500 which is spread over a finite number of times (the illustration shows 5 times: t−4, t−3, t−2, t−1, t).

The neural network 500 shown in FIG. 5 has an input layer 501 with five component input layers 521, 522, 523, 524 and 525 which respectively contain a prescribable number of input computing elements to which input variables xₜ₋₄, xₜ₋₃, xₜ₋₂, xₜ₋₁ and xₜ can be applied at prescribable times t−4, t−3, t−2, t−1 and t, i.e. time series values, described below, with prescribed time steps.

Input computing elements, i.e. input neurons, are connected via variable connections to neurons in a prescribable number of concealed layers 505 (the illustration shows 5 hidden layers).

In this case, neurons in a first 531, a second 532, a third 533, a fourth 534 and a fifth 535 concealed layer are respectively connected to neurons in the first 521, the second 522, the third 523, the fourth 524 and the fifth 525 component input layer.

The connections between the first 531, the second 532, the third 533, the fourth 534 and the fifth 535 concealed layer and, respectively, the first 521, the second 522, the third 523, the fourth 524 and the fifth 525 component input layer are each the same. The weights of all the connections are respectively contained in a first connection matrix B₁.

In addition, the neurons in the first concealed layer 531 are connected from their outputs to inputs of neurons in the second concealed layer 532 in accordance with a structure governed by a second connection matrix A₁. The neurons in the second concealed layer 532 are connected from their outputs to inputs of neurons in the third concealed layer 533 in accordance with a structure governed by the second connection matrix A₁. The neurons in the third concealed layer 533 are connected from their outputs to inputs of neurons in the fourth concealed layer 534 in accordance with a structure governed by the second connection matrix A₁. The neurons in the fourth concealed layer 534 are connected from their outputs to inputs of neurons in the fifth concealed layer 535 in accordance with a structure governed by the second connection matrix A₁.

Respective “inner” states or “inner” system states sₜ₋₄, sₜ₋₃, Sₜ₋₂, sₜ₋₁, and sₜ of a dynamic process described by the TDRNN are represented at five successive times t−4, t−3, t−2, t−1 and t in the concealed layers, the first concealed layer 531, the second concealed layer 532, the third concealed layer 533, the fourth concealed layer 534 and the fifth concealed layer 535.

The details in the indices in the respective layers respectively indicate the time t−4, t−3, t−2, t−1 and t to which the signals (xₜ₋₄, xₜ₋₃, xₜ₋₂, xₜ₋₁, xₜ) which can be tapped off on or supplied to the outputs of the respective layer relate in each case.

An output layer 520 has five component output layers, a first component output layer 541, a second component output layer 542, a third component output layer 543, a fourth component output layer 544 and a fifth component output layer 545. Neurons in the first component output layer 541 are connected to neurons in the first concealed layer 531 in accordance with a structure governed by an output connection matrix C₁. Neurons in the second component output layer 542 are likewise connected to neurons in the second concealed layer 532 in accordance with the structure governed by the output connection matrix C₁. Neurons in the third component output layer 543 are connected to neurons in the third concealed layer 533 in accordance with the output connection matrix C₁. Neurons in the fourth component output layer 544 are connected to Neurons in the fourth concealed layer 534 in accordance with the output connection matrix C₁. Neurons in the fifth component output layer 545 are connected to neurons in the fifth concealed layer 535 in accordance with the output connection matrix C₁. The output variables for a respective time t−4, t−3, t−2, t−1, t can be tapped off (yₜ₋₄, yₜ₋₃, yₜ₋₂, yₜ₋₁, yₜ) on the neurons in the component output layers 541, 542, 543, 544 and 545.

The principle that equivalent connection matrices in a neural network have the same values at a respective time is referred to as the principle of “shared weights”.

The arrangement which is known from [2] and is referred to as a Time Delay Recurrent Neural Network (TDRNN) is trained in a training phase such that a respective target variable yₜ^{d} is ascertained for an input variable xₜ on a real dynamic system. The tuple (input variable, ascertained target variable) is referred to as a training data item. A large number of such training data items form a training data record.

In this case, chronologically successive tuples (xₜ₋₄, yₜ₋₄^{d}) (xₜ₋₃, yₜ₋₃^{d}), (xₜ₋₂, yₜ₋₂^{d}) at the times (t−4, t−3, t−3, . . . ) in the training data record each have a prescribed time step.

The training data record is used to train the TDRNN. [1] likewise contains an overview of various training methods.

It should be stressed at this point that only the output variables yₜ₋₄, yₜ₋₃, . . . , yₜ at times t−4, t−3, . . . , t in the dynamic system 200 can be identified. The “inner” system states sₜ₋₄, sₜ₋₃, . . . , sₜ cannot be observed.

In the training phase, the following cost function E is normally minimized:

$$E = \frac{1}{T} {\sum }_{t = 1}^{T} {( {y}_{t} - {y}_{t}^{d} )}^{2} \to {min}_{f , g} , \qquad ( 4 )$$

where T denotes a number of times which are considered.

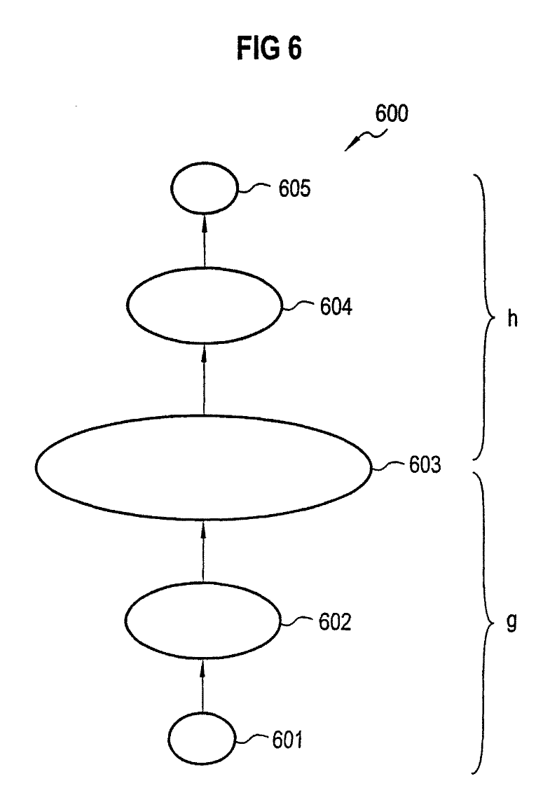

In addition, [3] contains an overview of principles of neural networks and the application options for neural networks in the field of economics.

[4] discloses a “neural autoassociator” (cf. FIG. 6).

The autoassociator 600 comprises an input layer 601, three hidden layers 602, 603, 604 and an output layer 605.

The input layer 601 and a first hidden layer 602 and a second hidden layer 603 form a unit which can be used to perform a first nonlinear coordinate transformation g.

The second hidden layer 603 forms, together with a third hidden layer 604 and the output layer 605, a second unit which can be used to perform a second nonlinear coordinate transformation h.

This five-layer neural network 600 known from [4] has the characteristic that an input variable xₜ is transformed to an inner system state in line with the first nonlinear coordinate transformation g. Starting from the second hidden layer 603, using the third hidden layer 604 through to the output layer 605, the second nonlinear coordinate transformation h is used to transform the inner system state essentially back to the input variable xₜ. The aim of this known structure is to map the input variable xₜ in a first state space X onto the inner state sₜ in a second state space S, the dimension of the second state space Dim(S) being meant to be smaller than the dimension of the first state space Dim(X) in order to achieve data compression in the concealed layer of the neural network. In this case, transformation back into the first state space X is equivalent to decompression.

The known arrangements and methods have the particular drawback that they can be used only to describe the current state of a process for an input variable xₜ at a current time t or for an input variable xₜ₋₁ at a time t−1 chronologically preceded by a prescribed time step. A future subsequent state of the process which follows chronologically after a prescribable time step or future subsequent states of the process which follow one another chronologically after a respective prescribable time step cannot be described or predicted in most cases.

The invention is thus based on the problem of specifying an arrangement of interconnected computing elements which can be used to describe one or more chronologically successive future subsequent states of a dynamic process.

The invention is also based on the problem of specifying a method for computer-aided ascertainment of one or more chronologically successive future subsequent states of a dynamic process.

The problems are solved by an arrangement and a method having the features claimed in the independent claims.

The arrangement of interconnected computing elements has:

at least one first computing element which can be used to transform a first state of a system in a first state space into a third state of the system in a second state space,

at least one second computing element which can be used to ascertain a fourth state of the system in the second state space,

at least one third computing element which has a respective connection to the first computing element and to the second computing element and can be used to determine a discrepancy between the third state and the fourth state,

at least one fourth computing element which has a respective connection to the first computing element and to the third computing element and can be used to determine a second state of the system in the first state space using the discrepancy and the first state.

In the case of the method for computer-aided ascertainment of a second state of a system in a first state space from a first state of the system in the first state space, the first state is transformed into a third state of the system in a second state space. A fourth state of the system in the second state space is ascertained and a discrepancy between the third state and the fourth state is determined. The discrepancy and the first state are used to ascertain the second state.

The arrangement is particularly suitable for carrying out the inventive method or one of its developments, which are explained below.

The invention can be used, in particular, to predict a plurality of subsequent states of a dynamic process which respectively follow one another after a prescribable time step. This means that states of the dynamic process can also be predicted over a long period of time.

In addition, the invention can be understood to be a technical model for human (“inner”) perception of an (“outer”) real event or of a formation of an (“inner”) conception of a future, (“outer”) real event (“Cognitive System”). In this case, the inner conception of the future event depends on the inner conception of the current, outer event and on a discrepancy between the inner conception of the current event and the outer, perceived current event.

Preferred developments of the invention can be found in the dependent claims.

The subsequently described developments relate both to the method and to the arrangement.

The invention and the subsequently described developments can be implemented both in software and in hardware, for example using a specific electrical circuit.

In addition, it is possible to implement the invention or a subsequently described development using a computer-readable storage medium storing a computer program which implements the invention or development.

It is also possible to implement the invention and/or any subsequently described development using a computer program product which has a storage medium storing a computer program which implements the invention and/or development.

To improve a degree of accuracy with which the second state of the system can be ascertained, a plurality of first computing elements, a plurality of second computing elements, a plurality of third computing elements and/or a plurality of fourth computing elements are preferably used.

To simplify a structure of interconnected computing elements, it is advantageous to combine the first computing element, the second computing element, the third computing element and the fourth computing element to form a subarrangement.

To predict a plurality of subsequent states of the system, a plurality of such first subarrangements are preferably used. In such an arrangement, at least a first one the first subarrangements and a second one of the first subarrangements are connected to one another such that the fourth computing element in the first of the first subarrangements is identical to the first computing element in the second of the first subarrangements.

To improve a prediction of subsequent states of the system, it is advantageous to extend the first subarrangement by a second subarrangement, which second subarrangement comprises:

a fifth computing element which can be used to transform a fifth state of the system in the first state space into a sixth state of the system in the second state space, and

a sixth computing element which has a connection to the fifth computing element and can be used to ascertain a seventh state of the system in the second state space,

a seventh computing element which has a connection to the fifth computing element and can be used to determine an eighth state of the system in the first state space,

where the second subarrangement is connected to the first subarrangement such that the fourth computing element and the fifth computing element are identical.

One development comprises a first of a plurality of second subarrangements and a second of the plurality of second subarrangements, where the first of the plurality of second subarrangements and the second of the plurality of second subarrangements are connected to one another such

that the fifth computing element in the second of the plurality of second subarrangements and the seventh computing element in the first of the plurality of second subarrangements are identical.

In one development, the arrangement is a neural network structure in which at least some of the computing elements are artificial neurons and/or at least some of the connections have respectively associated weights. During training of the neural network structure, the weights are altered.

One development is implemented on the basis of a principle of “shared weights”, where the weights of identical connections are identical.

In one refinement, the weights of the connection between the second computing element and the third computing element form the negative identity matrix.

When predicting a future state of the system, the second state is a state of the system which follows the first state after a prescribable time step.

In one refinement, the first state, the second state, the fifth state and the eighth state form part of a time series.

One development is used for ascertaining a dynamic response for the system. In this case, the dynamic response is ascertained using the time series.

One refinement has a measurement arrangement for detecting physical signals which can be used to describe a state of the system.

Developments can also be used for ascertaining the dynamic response of a dynamic process in a chemical reactor, for ascertaining the dynamic response of an electrocardiogram and for ascertaining an economic or macroeconomic dynamic response.

In complex systems, a state of the system is described by a vector of prescribable dimension.

Exemplary embodiments of the invention are illustrated in figures and are explained in more detail below.

In the drawings,

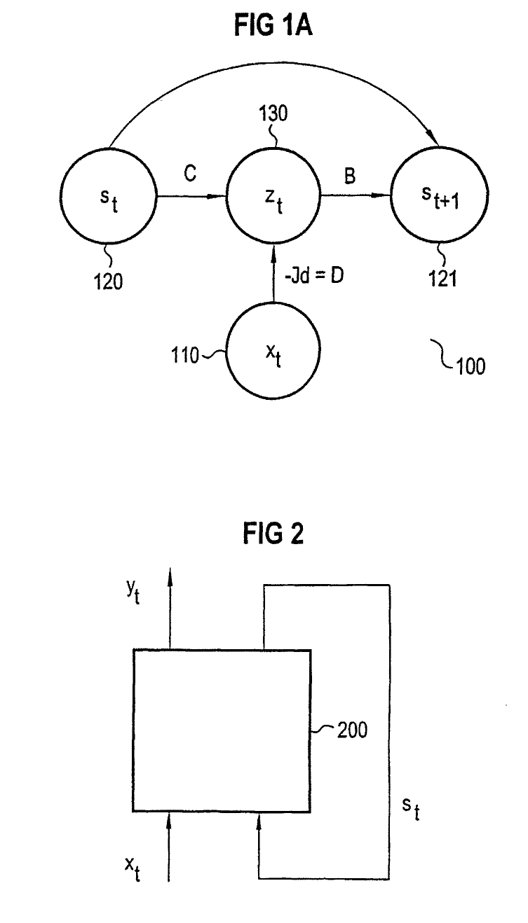

FIGS. 1a and 1b show sketches of a substructure and sketches of an overall structure in accordance with a first exemplary embodiment;

FIG. 2 shows a sketch of a general description of a dynamic system;

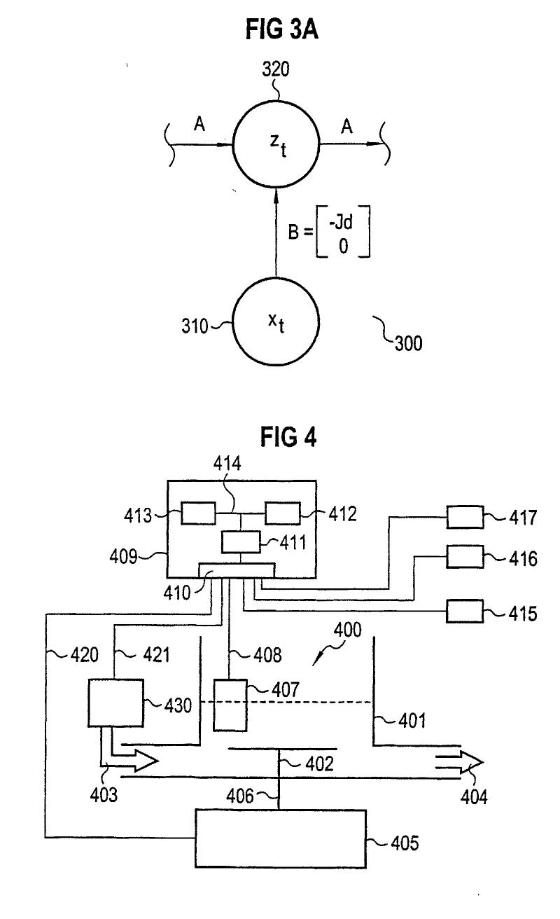

FIGS. 3a and 3b show sketches of a substructure and sketches of an overall structure in accordance with a second exemplary embodiment;

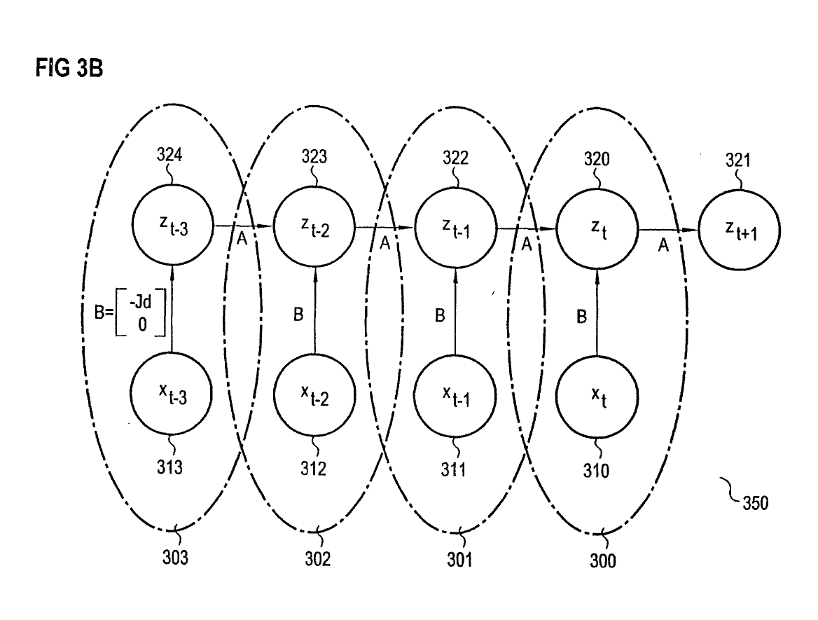

FIG. 4 shows a sketch of a chemical reactor for which variables are measured which are processed further using the arrangement in accordance with the first exemplary embodiment;

FIG. 5 shows a sketch of an arrangement of a TDRNN which is spread over time with a finite number of states;

FIG. 6 shows a sketch of an autoassociator in accordance with the prior art;

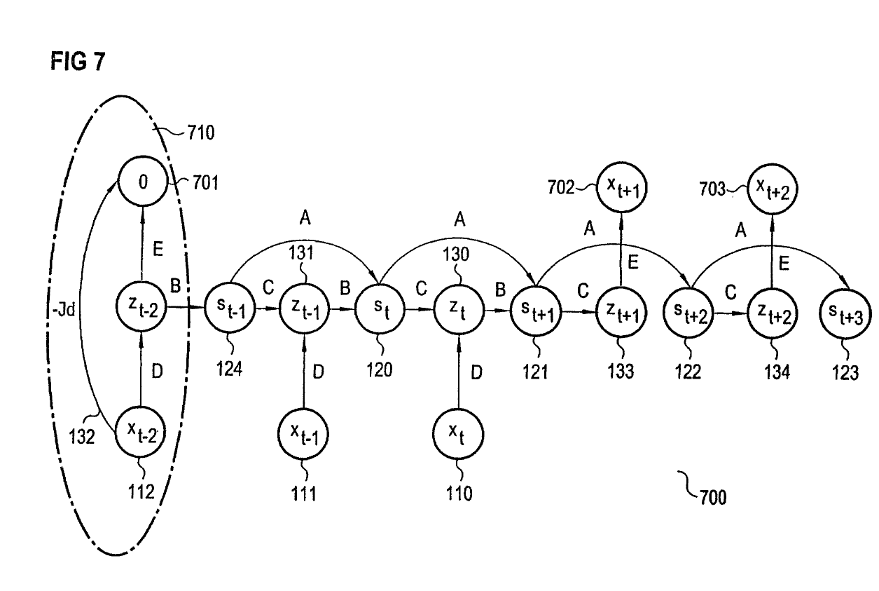

FIG. 7 shows a sketch of an alternative network structure;

First Exemplary Embodiment: Chemical Reactor

FIG. 4 shows a chemical reactor 400 which is filled with a chemical substance 401. The chemical reactor 400 comprises a stirrer 402 which is used to stir the chemical substance 401. Further chemical substances 403 flowing into the chemical reactor 400 react during a prescribable time period in the chemical reactor 400 with the chemical substance 401 which the chemical reactor 400 already contains. A substance 404 flowing out of the reactor 400 is passed out of the chemical reactor 400 via an outlet.

The stirrer 402 is connected by means of a line to a control unit 405 which can be used to set a stirring frequency for the stirrer 402 by means of a control signal 406.

In addition, a measurement unit 407 is provided which is used to measure concentrations of chemicals which the chemical substance 401 contains.

Measurement signals 408 are supplied to a computer 409, are digitized in the computer 409 using an input/output interface 410 and an analog/digital converter 411 and are stored in a memory 412. In the same way as the memory 412, a processor 413 is connected to the analog/digital converter 411 via a bus 414. The computer 409 is also connected via the input/output interface 410 to the controller 405 for the stirrer 402, and the computer 409 thus controls the stirring frequency of the stirrer 402.

The computer 409 is also connected via the input/output interface 410 to a keyboard 415, to a computer mouse 416 and to a screen 417.

The chemical reactor 400, as a dynamic technical system 200, is thus subject to a dynamic process and has a dynamic response.

The chemical reactor 400 is described using a state description. The input variable xₜ is in this case composed of details of the temperature in the chemical reactor 400, of the pressure in the chemical reactor 400 and of the stirring frequency which is set at the time t. The input variable is thus a three-dimensional vector.

The aim of the subsequently described modeling of the chemical reactor 400 is to determine the dynamic development of the substance concentrations in order thus to allow efficient production of a prescribable target substance which is to be produced as the substance 404 flowing out.

This is done using the subsequently described arrangement shown in FIG. 1a (neural substructure) and in FIG. 1b (neural overall structure), which is a neural network containing artificial neurons.

To assist understanding of the principles on which the arrangement is based, FIG. 1a shows a substructure of the overall structure.

The neural substructure 100 shown in FIG. 1a has an input neuron 110, to which input variables xₜ can be applied at prescribable times t, i.e. subsequently described time series values with prescribed time steps. The input variable xₜ is a multidimensional vector in a first state space x (input space x) of the system.

The input neuron 110 is connected to a first intermediate neuron 130 via a variable connection which has weights contained in a first connection matrix D. The first connection matrix D is the negative identity matrix −Id.

A second intermediate neuron 120 is connected to the first intermediate neuron 130 via a variable connection, the variable connection having weights which are contained in a second connection matrix C.

The first intermediate neuron 130 is also connected to a third intermediate neuron 120 via a further variable connection, the variable connection having weights which are contained in a third connection matrix B.

In addition, the second intermediate neuron 120 and the third intermediate neuron 121 are connected via a variable connection, the variable connection having weights which are contained in a fourth connection matrix A.

The second intermediate neuron 120 and a third intermediate neuron 121 represent two chronologically successive states t, t₊₁ of the system sₜ, sₜ₊₁ in a second state space s (“inner state space”) of the system.

The state sₜ of the system which is represented in the second intermediate neuron 120 is transformed into the first state space x, so that a difference zₜ between the transformed state and a state described using the input variable xₜ is formed in the first intermediate neuron 130. The difference zₜ likewise describes a state of the system in the first state space x.

Thus, the state sₜ₊₁ represented in the third intermediate neuron 121 is dependent, in accordance with the following rule, on the difference between the input variable xₜ and the state sₜ of the system at the preceding time t, on the state sₜ of the system at the preceding time t and on the weight matrices A, B, C and D:

sₜ₊₁=NN(A,B,C,D,sₜ,sₜ−xₜ), (5)

where NN(.) denotes a mapping rule prescribed by the neural network structure shown in FIG. 1a.

FIG. 1b shows the overall structure 150 of the neural network, which has two 100, 160 of the substructures 100 described above and shown in FIG. 1a.

In this case, it should be noted that it is also possible for more than two substructures 100, 160 to be connected to one another as described below.

The connection of the substructures 100, 160 results in a neural network 150 which is spread over the times t−1, t and t+1 and is used to model a map

sₜ₊₁=g(sₜ−xₜ,sₜ), (6)

where g(.) denotes the mapping rule.

The neural network 150 is based on the principle of shared weights, i.e. equivalent connection matrices have the same weights at a respective time.

The substructures 100 and 160 are connected such that the third intermediate neuron 120 in the first substructure 160 and the first intermediate neuron 120 in the second substructure 100 are identical.

To spread the neural network to an earlier state t−2 of the system, the overall structure 150 shown in FIG. 1b has an initial input neuron 112 and an initial intermediate neuron 132. The initial input neuron 112 is connected to the initial intermediate neuron 132 via a variable connection, the variable connection having weights which are contained in the first connection matrix D.

The initial intermediate neuron 132 is connected to the second intermediate neuron 124 in the first substructure 160 via a variable connection, the variable connection having weights which are contained in the second connection matrix B.

The initial input neuron 112 and the initial intermediate neuron 132 respectively represent a state of the system at the time t−2.

To spread the neural network to later or future states t+1, t+2 and t+3 of the system, the overall structure 150 in FIG. 1b has a fourth intermediate neuron 133. The fourth intermediate neuron 133 is connected to the third intermediate neuron 121 in the second substructure 100 via a variable connection, the variable connection having weights which are contained in the second connection matrix C.

FIG. 1b shows a fifth intermediate neuron 122 which [lacuna] connected to the third intermediate neuron 121 in the second substructure 100 via a variable connection, the variable connection having weights which are contained in the fourth connection matrix A.

The fifth intermediate neuron 122 has a sixth intermediate neuron 134 connected to it via a variable connection. This connection has weights which are contained in the second connection matrix C.

In addition, the fifth intermediate neuron 122 has a seventh intermediate neuron 123 connected to it via a variable connection. This connection has weights which are contained in the fourth connection matrix A.

The fourth intermediate neuron 133 represents a state of the system at the time t+1. The fifth intermediate neuron 122 and the sixth intermediate neuron 134 respectively represent a state of the system at the time t+2. The seventh intermediate neuron 123 represents a state of the system at the time t+3.

On the basis of the described structure of the neural network 150, respective time series values describing future states t+1, t+2 of the system can be tapped off on the fourth intermediate neuron 133 and on the sixth intermediate neuron 134. This allows the neural network 150 to be used for predicting system states.

The ability of the neural network 150 to predict can be attributed in structural terms to the fact that the fourth intermediate neuron 133 and the sixth intermediate neuron 134 respectively have no associated input neuron (cf. substructure 100, FIG. 1a).

As can clearly be seen, in this case no difference is formed in the fourth intermediate neuron 133 and the sixth intermediate neuron 134, but rather the future inner system state sₜ₊₁ ascertained in the third intermediate neuron 121 in the second substructure 100 is transformed into the input space x, and the future inner system state sₜ₊₂ ascertained in the fifth intermediate neuron 122 is transformed into the input space x.

The particular advantage which the arrangement shown in FIG. 1b has as a result of its structure, in particular, is that the arrangement allows efficient training using only a few training data items. This is possible particularly since the respectively identical weights in the connection matrices A, B and C mean that few weight parameters need to be set (“shared weights”).

The neural network 150 described is trained using a method based on a back-propagation process, as is described in [1].

During training of the neural network 150 described, the weights respectively contained in the connection matrices A, B and C are altered or aligned.

In addition, during the training, the intermediate neurons in which difference states are formed, that is to say the initial intermediate neuron 132, the first intermediate neuron 131 in the first substructure 100, the first intermediate neuron 130 in the second substructure, the fourth intermediate neuron 133 and the sixth intermediate neuron 134, are respectively used as an “error-producing” output neuron with the target value zero.

As can clearly be seen, this forces the neural network 150 to bring a respective state based on an inner model (state space s) into line with an outer state (state space x).

In the training method known from [1], the following cost function E is minimized in the training phase:

$$E = \frac{1}{T} {\sum }_{t = 1}^{T} {( {y}_{t} - {y}_{t}^{d} )}^{2} \to {min}_{f , g} , \qquad ( 7 )$$

where T denotes a number of times which are considered.

The training method used is the back-propagation process. The training data record is obtained from the chemical reactor 400 in the manner below.

Concentrations are measured for prescribed input variables using the measurement unit 407 and are supplied to the computer 409, where they are digitized and are grouped as time series values xₜ in a memory together with the corresponding input variables, which correspond to the measured variables.

The arrangement in FIG. 1b is trained using the training data record and the cost function E.

The arrangement in FIG. 1b, trained in accordance with the training method described above, is used for ascertaining chemical variables in the chemical reactor 400 such that predicted variables zₜ₊₁ and Zₜ₊₂ are ascertained in an application phase of the arrangement for input variables at the times t−2, t−1 and t and are then used as control variables, after any conditioning of the ascertained variables which may be necessary, as control variables 420, 421 to the control means 405 for controlling the stirrer 402 or else to an inflow control device 430 for controlling the inflow of further chemical substances 403 in the chemical reactor 400 (cf. FIG. 4).

2nd Exemplary Embodiment: Rental Price Prediction

FIG. 3a (substructure, implicit illustration) and FIG. 3b (overall structure, implicit illustration) show further neural structures which are respectively equivalent to the neural structures in FIG. 1a and FIG. 1b, i.e. the same functional maps are described.

The neural structures shown in FIG. 3a and FIG. 3b are used for rental price prediction.

The input variable xₜ is in this case composed of details relating to a rental price, available housing, inflation and an unemployment rate, which details are respectively ascertained at the end of the year (December values) for a residential area which is to be investigated. The input variable is thus a four-dimensional vector. A time series for the input variables, which comprise a plurality of chronologically successive vectors, has time steps of one year in each case.

The aim of the subsequently described modeling of rental price formation is to predict a rental price.

The dynamic process of rental price formation is described using the subsequently described neural network structures shown in FIG. 3a (substructure 300, implicit illustration) and in FIG. 3b (overall structure 350, implicit illustration).

The neural substructure 300 shown in FIG. 3a has an input neuron 310, to which input variables xₜ can be applied at prescribable times t, i.e. subsequently described time series values with prescribed time steps. The input variable xₜ is a multidimensional vector in a first state space x (input space x) of the system.

The input neuron 310 is connected to a first intermediate neuron 320 via a variable connection having weights which are contained in a first connection matrix B.

The first connection matrix B is an extended negative identity matrix which has been extended such that the negative identity matrix −Id has had row vectors each containing zero values added to it. Zero rows are added to the negative identity matrix −Id in line with a dimensional difference exhibited by the input space x with few dimensions and by the “inner system state space” z with a large number of dimensions.

FIG. 3b shows the overall structure 350 of the neural network, in which four 300, 301, 302, 303 of the previously described substructure 300 shown in FIG. 3a are connected to one another.

It should be noted in this case that it is also possible for more than four substructures 300, 301, 302 and 303 to be connected to one another as described below.

The connection of the substructures 300, 301, 302 and 303 results in a neural network spread over the times t−3, t−2, t−1 and t with “shared weights”.

The substructures 300, 301, 302 and 303 are connected such that the intermediate neuron 320 or 322 or 323 or 324 in a first substructure 300 or 301 or 302 or 303 is respectively connected to an intermediate neuron 320, 322 or 323 or 324 in a second substructure 300 or 301 or 302 or 303.

The connections each have weights which are contained in a second connection matrix A (“shared weights”).

To spread the neural network to a later or future state t+1 of the system, the overall structure 350 in FIG. 3b has a further intermediate neuron 321. The further intermediate neuron 321 is connected to the intermediate neuron 320 of the substructure 300 via a variable connection, the variable connection having weights which are contained in the second connection matrix A.

On the basis of the described structure of the neural network 350, time series values describing future states t+1 of the system can be tapped off on the further intermediate neuron 321. This allows the neural network 350 to be used to predict system states.

This ability to predict can be attributed in structural terms to the fact that the further intermediate neuron 321 has no connection to an associated input neuron (cf. first exemplary embodiment).

The particular advantage which the arrangement shown in FIG. 3b has as a result of its structure, in particular, is that the arrangement allows efficient training using only a few training data items. This is possible particularly since the respectively identical weights in the connection matrix A mean that only a few weight parameters (cf. first exemplary embodiment: connection matrices A, B and C) need to be set.

The arrangement described above is trained using a method based on a back-propagation process, as is described in [1].

During training of the neural network described, only the weights which are contained in the connection matrix A are altered or aligned.

In the training method known from [1], the following cost function E is minimized in the training phase:

$$E = \frac{1}{T} {\sum }_{t = 1}^{T} {( {y}_{t} - {y}_{t}^{d} )}^{2} \to {min}_{f , g} , \qquad ( 10 )$$

where T denotes a number of times which are considered.

The text below indicates a few alternatives to the exemplary embodiments described above.

The arrangements described in the exemplary embodiments can each also be used for ascertaining a dynamic response for an electrocardiogram (ECG). Indicators pointing to an increased risk of heart attack can thus be determined early. The input variable used is a time series comprising ECG values measured on a patient.

In addition, the arrangements described in the exemplary embodiments can also be used to predict a macroeconomic dynamic response, such as an exchange rate profile, or other economic coefficients, such as a stock market index. For predictions of this nature, an input variable is formed from time series for relevant macroeconomic or economic coefficients, such as interest rates, currencies or inflation rates.

FIG. 7 shows an alternative network structure to the neural network structure described within the scope of the first exemplary embodiment.

Identical structure elements have the same references in FIG. 7 and FIG. 3a and in FIG. 3b.

In the case of the alternative network structure in FIG. 7, the initial intermediate neuron 132 is connected to an initial output neuron 701. The initial output neuron 701 is a null neuron.

The connection between the initial intermediate neuron 132 and the initial output neuron 701 has variable weights which are contained in a connection matrix E.

In addition, the initial input neuron 112 is connected to the initial output neuron 701. The connection matrix F for this connection is the negative identity matrix −Id.

A substructure 710 comprising the initial input neuron 112, the initial intermediate neuron 132 and the initial output neuron 701 has the functionality of a neural autoassociator.

A neural autoassociator is known from [4] (cf. FIG. 6).

The fourth intermediate neuron 133 and the sixth intermediate neuron 134 are respectively connected to an output neuron 702 and 703. The associated connections each have weights in the connection matrix E.

The output neuron 702 represents a state xₜ₊₁ of the system at the time t+1 in the first state space x. The output neuron 703 represents a state xₜ₊₂ of the system at the time t+1 in the first state space x.

The text below shows possible implementations of the first and second exemplary embodiments described above for the program SENN, Version 2.3. The implementations respectively comprise three sections, each containing a program code, which are required for processing in SENN, Version 2.3.

Implementation for the first exemplary embodiment:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

The following publications have been cited in this document:

[1] S. Haykin, Neural Networks: a Comprehensive Foundation, McMillan College Publishing Company, Second Edition, ISBN 0-13-273350-1, pp. 732-789, 1999

[2] David E. Rumelhart et al., Parallel Distributed Processing, Explorations in the Microstructure of Cognition, Vol. 1: Foundations, A Bradford Book, The MIT Press, Cambridge, Mass., London, England, 1987

[3] H. Rehkugler and H. G. Zimmermann, Neuronale Netze in der Ökonomie, Grundlagen und finanzwirt-schaftliche Anwendungen [Neural Networks in Economics, Principles and Financial Applications], Verlag Franz Vahlen Munich, ISBN 3-8006-1871-0, pp. 3-90, 1994

[4] Ackley, Hinton, Senjnowski, A learning algorithm for Boltzmann machines, Cognitive Science, 9, pp. 147-169, 1985.

1. An arrangement of interconnected computing elements,
having at least one first computing element which can be used to transform a first state of a system in a first state space into a third state of the system in a second state space,
having at least one second computing element which can be used to ascertain a fourth state of the system in the second state space,
having at least one third computing element which has a respective connection to the first computing element and to the second computing element and can be used to determine a discrepancy between the third state and the fourth state,
having at least one fourth computing element which has a respective connection to the first computing element and to the third computing element and can be used to determine a second state of the system in the first state space using the discrepancy and the first state.

2. The arrangement as claimed in claim 1, in which the first computing element, the second computing element, the third computing element and the fourth computing element form a first subarrangement.

3. The arrangement as claimed in claim 1 or 2, having a plurality of first computing elements, a plurality of second computing elements, a plurality of third computing elements and/or a plurality of fourth computing elements.

4. The arrangement as claimed in claim 2 and 3, having a plurality of first subarrangements, where at least a first of the first subarrangements and a second of the first subarrangements are connected to one another such that the fourth computing element in the first of the first subarrangements is identical to the first computing element in the second of the first subarrangements.

5. The arrangement as claimed in one of claims 1 to 4, having at least one second subarrangement, which second subarrangement comprises:
a fifth computing element which can be used to transform a fifth state of the system in the first state space into a sixth state of the system in the second state space, and
a sixth computing element which has a connection to the fifth computing element and can be used to ascertain a seventh state of the system in the second state space,
a seventh computing element which has a connection to the fifth computing element and can be used to determine an eighth state of the system in the first state space,
where the second subarrangement is connected to the first subarrangement such that the fourth computing element and the fifth computing element are identical.

6. The arrangement as claimed in claim 5, having a first of a plurality of second subarrangements and a second of the plurality of second subarrangements, where the first of the plurality of second subarrangements and the second of the plurality of second subarrangements are connected to one another such that the fifth computing element in the second of the plurality of second subarrangements and seventh computing element in the first of the plurality of second subarrangements are identical.

7. The arrangement as claimed in one of claims 1 to 6, comprising computing elements which are artificial neurons.

8. The arrangement as claimed in one of claims 1 to 7, in which at least some of the connections have respectively associated weights.

9. The arrangement as claimed in claim 8, in which the weights of identical connections are identical.

10. The arrangement as claimed in claim 8 or 9, in which the weights of the connection between the second computing element and the third computing element form the negative identity matrix.

11. The arrangement as claimed in one of claims 1 to 10, used for ascertaining a dynamic response for the system such that the dynamic response is ascertained from a time series comprising states of the system.

12. The arrangement as claimed in one of claims 1 to 11, having a measurement arrangement for detecting physical signals which can be used to describe a state of the system.

13. The arrangement as claimed in claim 11 or 12, used for ascertaining the dynamic response of a dynamic process in a chemical reactor.

14. The arrangement as claimed in claim 11 or 12, used for ascertaining the dynamic response of an electrocardiogram.

15. The arrangement as claimed in claim 11 or 12, used for ascertaining an economic or macroeconomic dynamic response.

16. The arrangement as claimed in one of claims 8 to 15, in which the weights can be altered when training the arrangement.

17. A method for computer-aided ascertainment of a second state of a system in a first state space from a first state of the system in the first state space
in which the first state is transformed into a third state of the system in a second state space,
in which a fourth state of the system in the second state space is ascertained,
in which a discrepancy between the third state and the fourth state is determined,
in which the discrepancy and the first state are used to ascertain the second state.

18. The method as claimed in claim 17, in which a state of the system is described by a vector of prescribable dimension.

19. The method as claimed in claim 17 or 18, in which the first state is a first time series value and the second state is a second time series value in a time series comprising time series values.
